(19) United States
(12) Patent Application Publication
(10) Pub. No.: US 2012/0089449 A1
(43) Pub. Date: Apr. 12, 2012

(54) System and Method for Providing a Promotion

(76) Inventors: Kevin Yu, Irvine, CA (US); Paul Della Bitta, Laguna Niguel, CA (US)

(21) Appl. No.: 12/899,783

(22) Filed: Oct. 7, 2010

(51) Int. Cl. G06Q 30/00

(52) U.S. Cl. 705/14.23; 705/1.1; 705/319; 235/375; 705/27.1

(57) ABSTRACT

A system and method for providing a promotion over a computer network includes determining a potential promotion for an item, determining a threshold number of uncommitted endorsements required to unlock the potential promotion, and displaying the potential promotion and the threshold number of uncommitted endorsements to at least one potential buyer over the computer network before the threshold number is reached. The method further includes receiving endorsement data including an actual number of uncommitted endorsements made over the computer network, tracking the actual number of uncommitted endorsements, and unlocking the potential promotion for the item when the actual number of uncommitted endorsements reaches the threshold number, thereby converting the potential promotion to an actual promotion.

### BACKGROUND OF THE INVENTION

Viral, word-of-mouth advertising is increasingly popular as a means for advertising a product or service with a high degree of credibility. Potential purchasers are more likely to purchase when the product or service has been recommended by someone they know and trust. Various Internet-related tools have implemented simple ways for individuals to publicly endorse items they like to their friends, acquaintances, or to the general public. One example of such a tool is the “Like” button/box social plug-in on Facebook.com, which allows social network users to endorse content, pages, etc. and have that endorsement show up on their personal and/or friends' profile pages simply by clicking on a link labeled “Like.” Other, similar social networking tools allow Internet users “buzz” or “tweet” about an item found on the Internet, and a link to that item is then announced to the user's network or the public via a website or feed.

These endorsements are “uncommitted,” meaning that they do not require an actual or contingent commitment to purchase an item or to purchase an option to buy an item. Thus, there are very few disincentives to providing an uncommitted endorsement. The public also tends to view them as highly credible. One problem, however, is that there are also very few incentives for Internet users to provide uncommitted endorsements. There is also very little that a seller of an item can do to encourage or control the endorsements the item receives, despite the tremendous value of such advertising.

Other methods of viral advertising are incentivized by providing a discount for group purchasing. The website groupon.com, for example, requires that an Internet user commit to purchasing a particular item contingent on the number of other committed purchases of that item reaching the number required for a group discount. This method incentivizes Internet users to promote the item to those in their network so that enough other people will commit to a contingent purchase that the group discount can be provided. Although there may be ways of getting out of a commitment once the contingency occurs, this typically incurs some penalty to de-incentivize breach of the commitment. If the users do not want to commit, have already purchased, or would rather purchase the item outright, however, they would likely not participate. Further, if enough users fail to contingently commit to purchase the item, the group discount is not provided.

Still other systems have been provided that allow users to purchase options to buy a product or service. If enough options are purchased, the product or service becomes available for purchase to those with options. Because these systems require purchase of options, however, they suffer from similar problems as the systems discussed above.

### SUMMARY OF THE INVENTION

A method for providing a promotion over a computer network includes determining a potential promotion for an item, determining a threshold number of uncommitted endorsements required to unlock the potential promotion, and displaying the potential promotion and the threshold number of uncommitted endorsements to at least one potential buyer over the computer network before the threshold number is reached. The method further includes receiving endorsement data including an actual number of uncommitted endorsements made over the computer network, tracking the actual number of uncommitted endorsements, and unlocking the potential promotion for the item when the actual number of uncommitted endorsements reaches the threshold number, thereby converting the potential promotion to an actual promotion.

In one embodiment, the uncommitted endorsements are endorsements for the item, and in another embodiment, the method further includes displaying the actual number of uncommitted endorsements before the threshold number is reached. The difference between the actual number of uncommitted endorsements and the threshold number may also be displayed before the threshold number is reached. In various embodiments, the displaying is on a website, through a social networking application, and on a mobile device.

In various embodiments, the uncommitted endorsements are provided through a social networking application, such as by users in a particular social network through the social networking application, and the tracking may include tracking the actual number of uncommitted endorsements made by the users in the particular social network. In one embodiment, the uncommitted endorsements are made by scanning a machine-readable code. In another embodiment, the uncommitted endorsements are made by registering entry into or a position at a location.

In one embodiment, the potential promotion and threshold number are displayed to a plurality of potential buyers and the unlocking includes converting the potential promotion to an actual promotion for a subset of the plurality of potential buyers. The subset may, for example, consist of those of the plurality of potential buyers who provided the uncommitted endorsements and/or those in their social network.

In one embodiment, the potential promotion is unlocked only for a predetermined window of time after the threshold number is reached. Alternatively or in addition, the potential promotion may be unlocked only for a predetermined number of sales.

In another embodiment, the method also includes providing an announcement that the potential promotion is unlocked when the threshold number is reached. This announcement may be provided, for example, on a website, a social networking application and/or a mobile device. In one embodiment, the announcement is provided to those of the one or more potential buyers who provided an uncommitted endorsement. In one embodiment, an announcement may be provided when the number of actual uncommitted endorsements is within a predetermined range of the threshold number.

In another embodiment, the potential promotion is converted to an actual promotion by displaying a coupon in a social networking application, which may be displayed on a personal page of a user of the social networking application.

In one embodiment, the tracking includes tracking users of the social networking application who made the uncommitted endorsements and the coupon is displayed on a personal page of a user who made at least one of the uncommitted endorsements. In a variation of this embodiment, a number of sales made through the coupon is tracked and a privileged status is granted to the user if the number of sales reaches a predetermined amount.

In another embodiment, a system for providing a promotion over a computer network includes a plurality of user terminals, each having a display, for displaying a potential promotion for an item and a threshold number of uncommitted endorsements required to unlock the potential promotion, and a user interface, for submitting user data signifying an uncommitted endorsement in response to the potential promotion. The embodiment further includes a retailer interface coupled via said computer network to the plurality of user terminals, the retailer interface for submitting retailer data signifying the potential promotion for the item and the threshold number of uncommitted endorsements. A promotion database is coupled to the plurality of user terminals and the retailer interface for receiving and storing the user data and retailer data. The system also includes a promotion processor coupled to plurality of user terminals, the retailer interface, and the promotion database for sending the potential promotion and the threshold number to the user terminal for display, analyzing the user data to determine an actual number of uncommitted endorsements received, comparing the actual number of uncommitted endorsements to the threshold number of uncommitted endorsements, and sending an announcement to at least one of the plurality of user terminals that the potential promotion is an actual promotion when the actual number of uncommitted endorsements is equal to or greater than the threshold number of uncommitted endorsements.

The foregoing aspects and other forms, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an architectural diagram showing one embodiment of a system according to the invention.

FIG. 2 is an architectural diagram showing another embodiment of a system according to the invention.

FIG. 3 is a process flow diagram showing a user experience according to one embodiment of the invention.

FIG. 4 is a sample retailer interface according to one embodiment of the invention.

FIG. 5 is a sample retailer interface according to another embodiment of the invention.

FIG. 6 is a sample mobile interface according to an embodiment of the invention.

FIG. 7 is a sample website interface according to another embodiment of the invention.

### DETAILED DESCRIPTION OF THE INVENTION

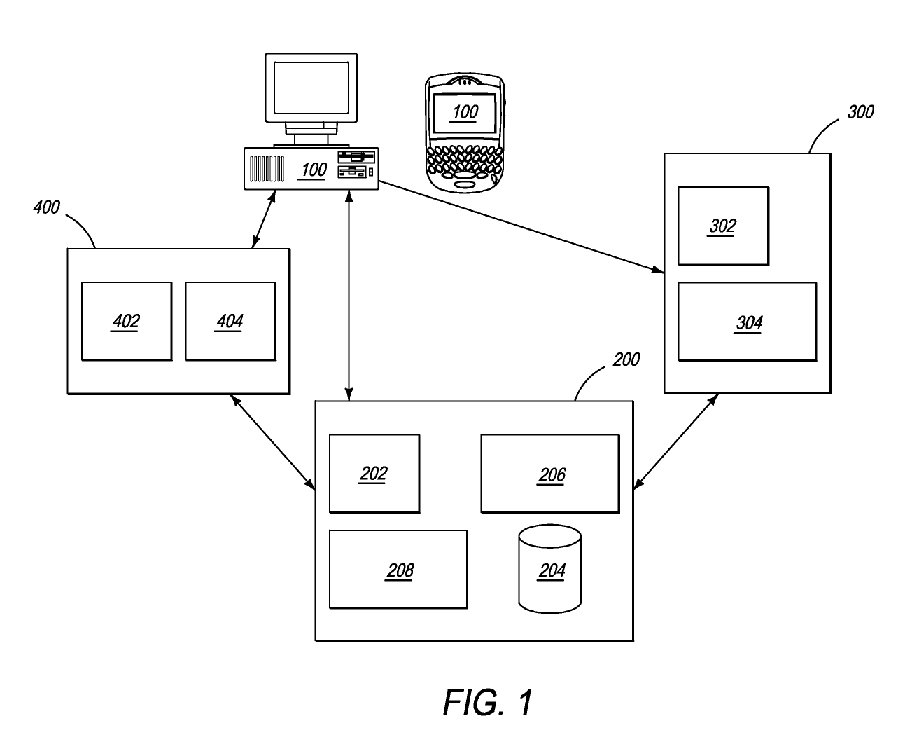

FIG. 1 is an architectural diagram showing one embodiment of a system according to the invention. A plurality of user terminals 100 are coupled through a public network to a promotion hub 200, a retailer server 300, and a social network server 400. The hub 200 includes an input handler 202, promotion database 204, processor 206, and a user updater 208. The retailer server 300 includes a retailer counter 302 and a retailer updater 304. The social network server 400 includes a user database 402 and an authentication server 404.

A potential promotion for an item is determined by a retailer selling that item. Instead of the promotion depending on a critical mass of committed buyers for the particular item, however, the retailer determines a threshold number of uncommitted endorsements that will be required to “unlock,” or release, the potential promotion for use. As discussed above, an “uncommitted endorsement” is defined herein as a recommendation that does not require a purchase or a contingent obligation to purchase something. The endorsements may be for a product, service, retailer, category of products, person, etc.

The potential promotion and the threshold number of uncommitted endorsements are determined by the retailer. With reference to FIG. 1, the potential promotion, threshold number, item information, and retailer information are transmitted through the retailer updater 304 of the retailer server 300 and stored in the promotion database 204 in the hub 200. The promotion database 204 also stores a number of actual uncommitted endorsements the item has already received, if any. This information is sent to the retailer server 300 to be displayed on the retailer's website along with a means for making an uncommitted endorsement for the item. This information and means may also or alternatively be sent to potential purchasers or endorsers via user terminals 100, through email, mobile application, social network server 400, and/or other suitable means. The user terminals 100 may be computers, mobile devices, telephones, connected entertainment devices or other devices in coupled communication with the promotion hub 200 through, for example, a public network.

In this embodiment, the means for providing an uncommitted endorsement is a button or link, such as a “like” button, which a user may click to indicate to other members of the user's social network that the user recommends the item. However, one having ordinary skill in the art will understand that the means may be provided in many different ways, including a text box, a request for return email/text message, mobile application, GPS tracking request, etc.

If a user at a user terminal 100 clicks the button to provide an uncommitted endorsement, the request is transmitted from the retailer's website, mobile application, or social networking server 400 to the input handler 202, which identifies and categorizes the information by retailer, product, and user and then stores this information in the promotion database 204. The information is then sent back to the retailer server 300, where the retailer counter 302 is updated to the current number of uncommitted endorsements. However, it is also within the scope of the invention to maintain the updated endorsement count at alternate or additional locations, such as the user database 402 of the social networking server 400 or solely at the promotion database 204. The updated endorsement count is then displayed on the user terminals 100 through email, mobile application, and/or social network server 400.

The retailer updater 304 may request analytic data from the promotion database 204 through the processor 206. For example, the retailer may request information on the number of uncommitted endorsements received via a social networking page versus through the retailer web site, the rate at which the uncommitted endorsements have been submitted, or influential users whose endorsements spawned the most additional endorsements.

Update of the social network server 400 according to one embodiment will now be described with reference to FIG. 1. A user's personal information, such as login, password, other linked users, etc. may be stored in the user database 402 of the social networking server 400. The user may log into the social networking site by providing authentication information to the authentication server 404. When the user clicks a recommend button displayed on the retailer's web site or social networking page, the user database 402 is updated to associate the user's account with the retailer's web site or social networking page, and the user's uncommitted endorsement of the item is displayed on the user's profile page. The retailer's potential promotion on the item, the threshold number of uncommitted endorsements required to unlock the promotion, and the updated endorsement count are also displayed on the user's profile page. A portion of the retailer's web site and a button allowing other users to recommend the item may also be visible on the user's profile page.

If the user is not already logged into the social networking site at the time the button is clicked, an authentication button may be sent to the user by the promotion hub 200 or authentication server 404 to collect and send the authentication information to the authentication server 404 along with the information on the user's uncommitted endorsement.

Once the endorsement count reaches the threshold number, the promotion hub 200 sends an update to the retailer server 300 that the threshold number has been reached. The retailer updater 304 then unlocks the potential promotion, sends this information to the promotion hub 200, and the user updater 208 sends announcements of the currently available promotion, such as a product discount, to the user terminals 100 through email, mobile application, and/or social network server 400. Users at user terminals 100 that receive the announcement can then purchase items at the provided discount from the retailer.

The user updater 208 may also send announcements when the number of uncommitted endorsements is nearing the threshold number. For example, announcements may be sent to users when the number of uncommitted endorsements reaches eighty percent of the threshold required to unlock the promotion. This announcement may encourage those receiving it to submit uncommitted endorsements for the item to speed up the unlocking of the promotion or to encourage their social network to do the same, thus providing an incentive for users to endorse the retailer's item.

The announcements may be sent to all users of the social network, those viewing the retailer's web site, those who have signed up to receive announcements of promotions through other means, etc. The announcements may alternatively be sent to a subset of these users, such as only those who have submitted uncommitted endorsements of the item. This would further encourage users to submit uncommitted endorsements of the product. In one embodiment, the announcements are sent only to those users who are considered “early adopters,” such as those who submit endorsements earlier in time, or “influencers,” such as those whose endorsements spawned many additional endorsements and/or purchases.

Although the “potential promotion” may be in the form of a discount off of the normal price of the item that is endorsed, the term “potential discount” is meant to encompass a much wider array of promotions, such as a potential discount off of a different product or service, a discount on bulk purchases, a free product or service with purchase of another product or service, a discount on an array of products from the same retailer, accessible content normally unavailable, etc.

The potential promotion may also be unlocked for only a specific time, location, or number of purchases/uses. It may also be unlocked for only a limited number of users, such as only those who have endorsed the item, early adopters, influencers, or a random subset of these users. It may also be unlocked through sending a coupon to certain users that may be used a certain number of times by those users and those in their networks or through providing a credit to those users' retailer membership account. It is also within the scope of the invention to unlock a discount for a particular user when a certain threshold number of endorsements are spawned by that user's endorsement.

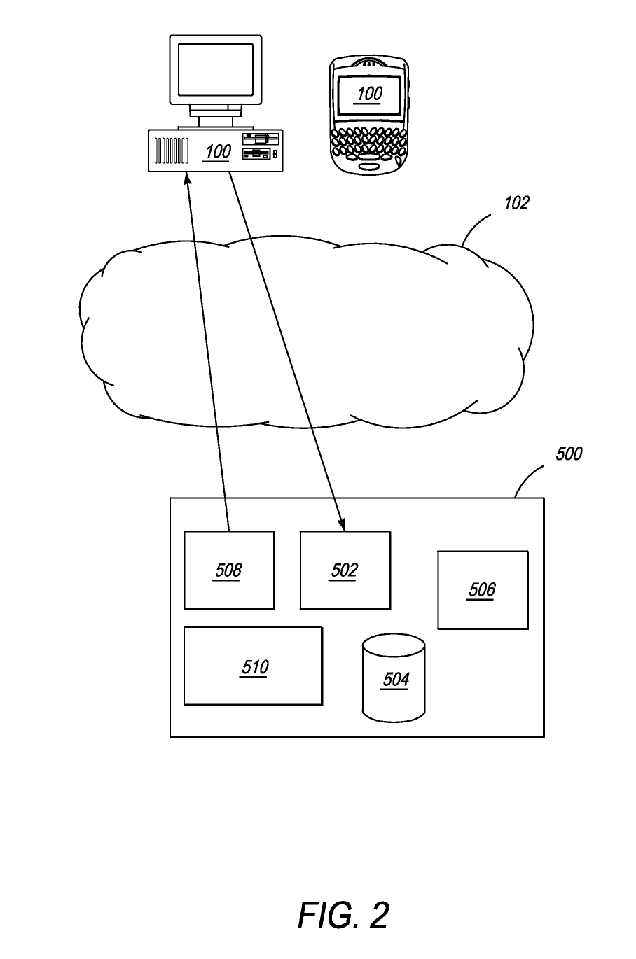

Although the embodiment described above is used in conjunction with a social networking server and promotion hub, it is also within the scope of the invention for the promotion database to be included with the retailer server or any other suitable location. One such embodiment is depicted in FIG. 2. User terminals 100, which may consist of computers, mobile phones, connected entertainment devices, etc., are coupled via a public network 102 to a retailer server 500. The retailer server 500 includes an input handler 502, a promotions database 504, a processor 506, a user updater 508, and a retailer counter 510. The input handler 502, promotions database 506, and user updater 508 perform substantially the same functions as described above in relation to FIG. 1, but they are controlled by the retailer, rather than a separate promotions hub. In operation, the uncommitted endorsements are received by the input handler 502, stored in the promotions database 504, and the retailer counter 510 is updated with the current tally of uncommitted endorsements. The number is displayed along with the potential promotion, number of uncommitted endorsements needed to unlock the promotion, and the current tally of uncommitted endorsements on the retailer website. The endorsing users' information may also be displayed to those visiting the site or a subset, such as those in the endorsing users' social network. The announcements and coupons are provided to the user terminals through the user updater 506 and provided by the retailer without necessary interface with a social networking server or promotion hub. Although not shown in FIG. 2, the retailer server 500 may also be coupled to a separate social networking server to update user and/or promotion information.

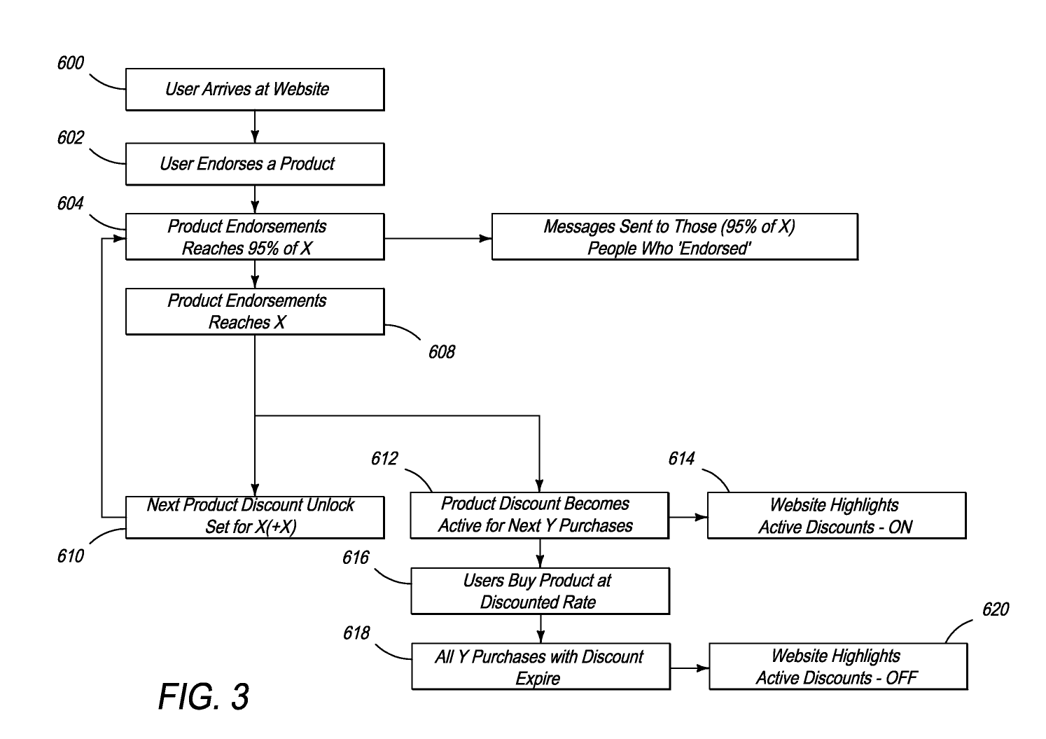

FIG. 3 is a process flow diagram depicting a user experience according to one embodiment of the invention. At step 600, a user arrives at a website and views products available for sale on the website, along with displayed promotions showing a discount available on a product if the number of endorsements of the product reaches a certain number X. At step 602, the user clicks a link to submit an uncommitted endorsement for the product. The uncommitted endorsement is processed according to the embodiments previously described, and the retailer counter is updated with the new total of uncommitted endorsements during the promotional period. At step 604, the counter reaches ninety-five percent of the threshold number X, and a message is sent at step 606 via social networking site, email, etc. to those users who submitted uncommitted endorsements.

When the number of uncommitted endorsements reaches the threshold number X at step 608, an additional potential discount is displayed on the website at step 610 that would be available for use after the number of uncommitted endorsements reaches X+X. In addition, the original potential discount is unlocked at step 612 and becomes an actual discount for the next Y purchases. The website highlights that the discount is available at step 614.

At step 616, the users buy the product at the discounted rate until all Y purchases with discount expire at step 618. At step 620, the website displays that the discount has expired.

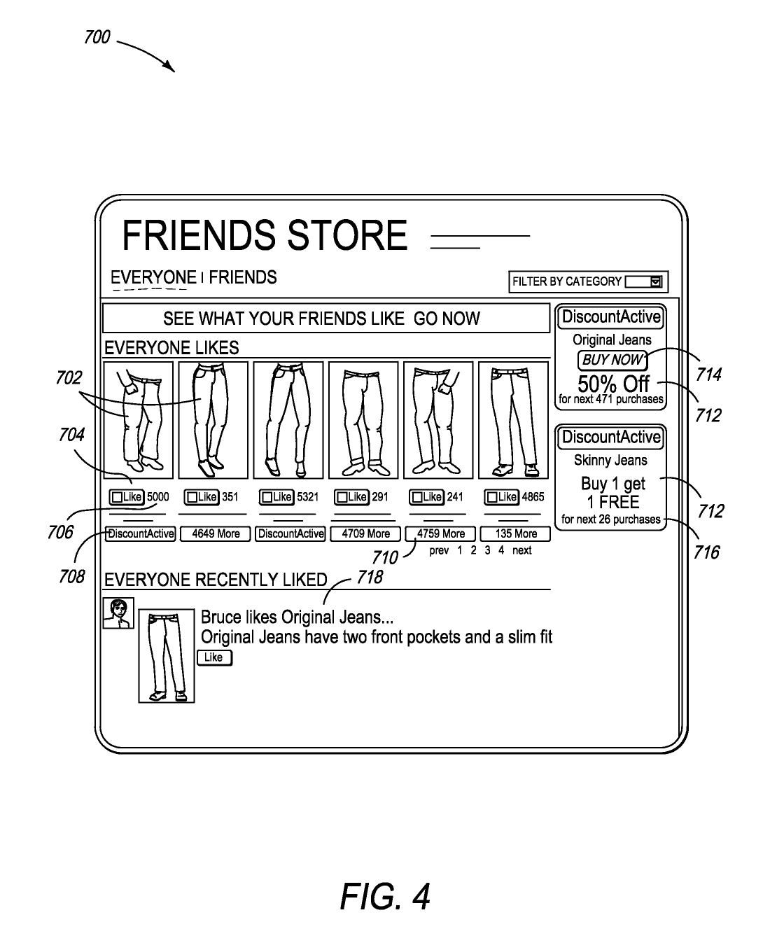

FIG. 4 shows a sample retailer website interface 700 according to one embodiment of the invention. As shown in FIG. 4, a plurality of products 702 are displayed on the website interface 700 with associated information related to means 704 for submitting an uncommitted endorsement and the current number of uncommitted endorsements received for that product 706. After the threshold number of uncommitted endorsements has been reached, the website displays an indication that the discount is active 708. If the threshold number has not yet been reached, the website indicates that the discount is not yet active 710 and the number of additional uncommitted endorsements needed for the discount to become active. Additional information 712 is displayed on the website that outlines the details of the active discounts, provides a means for using a discount 714, and displays the number of purchases left on the discount 716. As shown in this embodiment, information regarding endorsements provided by other members of the user's network 718 is displayed as well.

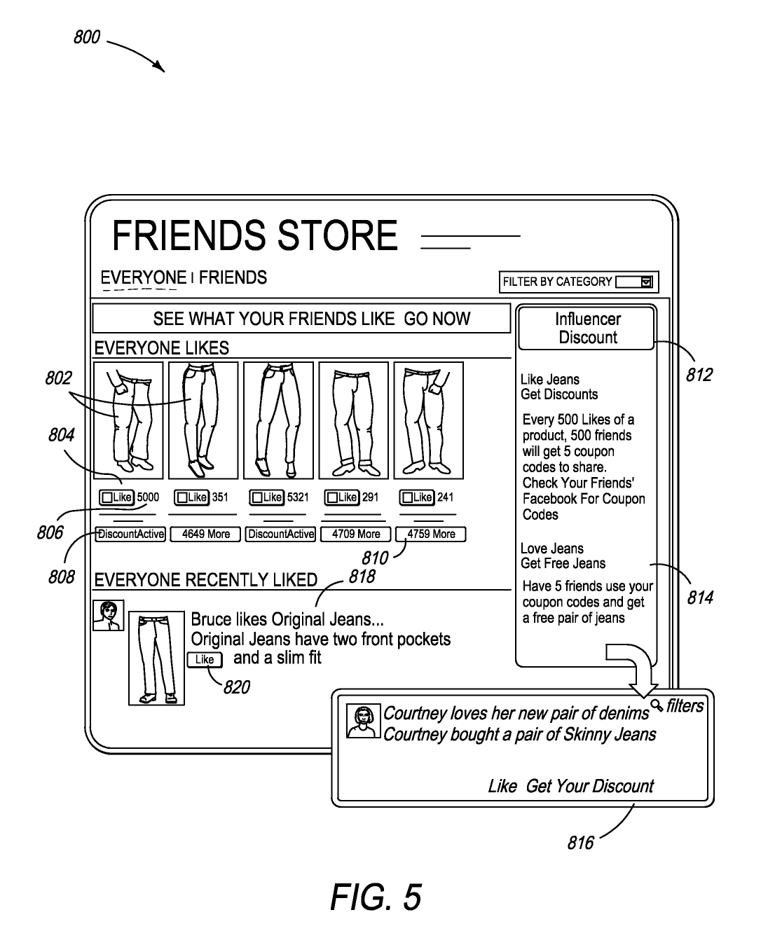

FIG. 5 shows a sample retailer website interface 800 according to another embodiment of the invention. Like the embodiment described above, this embodiment of the retailer website interface 800 also displays a plurality of products 802, means for submitting an uncommitted endorsement 804, the number of uncommitted endorsements the product has received 806, indicia of whether the discount is active 808, or inactive 810, along with the number of additional uncommitted endorsements required for the inactive discounts to become active. In this embodiment, additional information 812 is displayed on potential discounts, including the number of endorsements required for them to be unlocked.

Discounts may also be provided through members of the user's social network through, for example, coupons 816 published to those members' accounts. As shown, the coupon was sent to one user, but the discount was shared with the user's social network via interface with a social networking site. Details on potential influencer promotions 814 may also be displayed on the website.

Endorsements submitted by members of the users' social network 818 and means for submitting an uncommitted endorsement spawned from those users' endorsements 820 are also shown in FIG. 5. As discussed above, the number of endorsements spawned from a user's endorsement may be tracked to provide influencer incentives.

As described above, uncommitted endorsements may be made through clicking a button or link on a retailer's website or in a social networking application, but it is also within the scope of the invention for uncommitted endorsements to be submitted through additional means. For example, an uncommitted endorsement may be submitted by scanning a machine-readable code affixed to the endorsed item with a mobile device. When the item is scanned, the item information is transmitted to the promotions database and an uncommitted endorsement is logged for that user and that item.

In another embodiment, an uncommitted endorsement may be submitted by transmitting the user's GPS coordinates when visiting a particular location. For example, a potential discount may be displayed that for every five hundred shoppers that “check-in” to a location by registering their GPS location at a particular place, five random shoppers will receive a discount on their mobile device to be used within the next two hours. This promotion may be combined with, for example, the machine-readable code scanning method discussed above to further tailor the potential promotions provided to the interests of the shoppers.

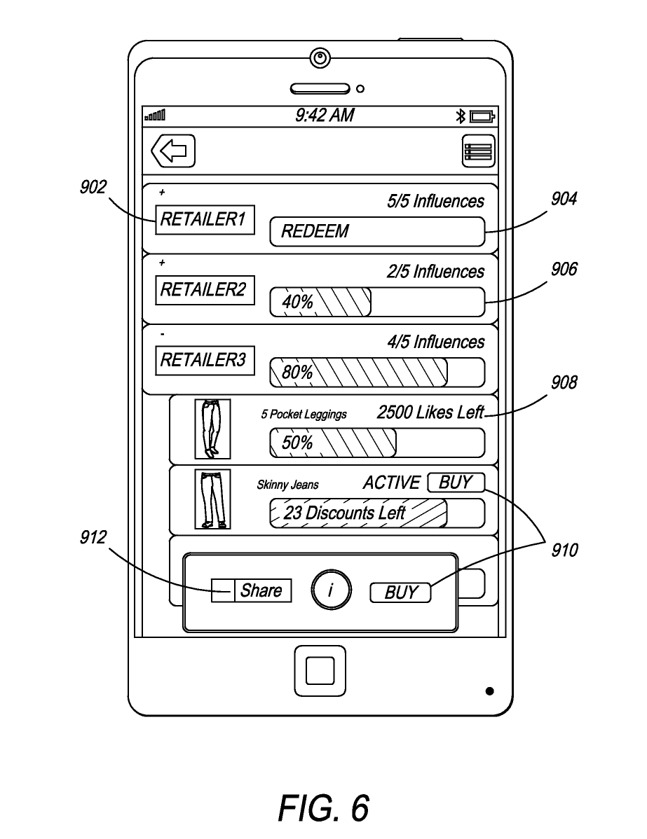

FIG. 6 shows a sample mobile device interface 900 according to another embodiment of the invention. A plurality of promotions may be tracked on a device to provide real-time updates of the availability of discounts and to provide incentives for urgent action. A plurality of retailers 902 may be displayed on the mobile device screen along with means 904 to redeem active promotions. Promotions may relate to discounts based on the number of influences 906 and/or the number of uncommitted endorsements 908 received. For active discounts, means for using the discount and the number of discounts remaining 910 may be displayed. Means for publicizing the potential discount, active discount, etc. may also be displayed on the mobile device interface 912. Although a mobile device interface is depicted in FIG. 6, it will be appreciated that multiple promotions may be tracked via other forms of user terminals as well.

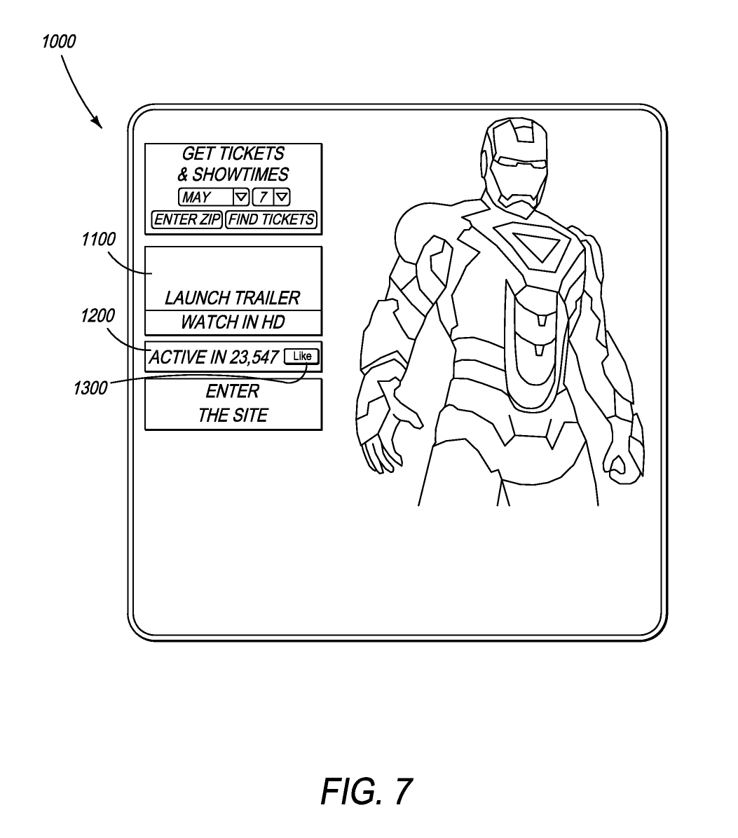

Although the above embodiments are described in terms of unlockable discounts, it is also within the scope of the invention to provide unlockable promotions in many forms, such as unlockable content when a threshold number of uncommitted endorsements are submitted. FIG. 7, for example, shows one embodiment of a website interface 1000 displaying details on a movie trailer 1100 that may be viewed when a threshold number of uncommitted endorsements 1200 is reached, along with a means for submitting an uncommitted endorsement 1300. Once the number of uncommitted endorsements for the movie reaches the threshold number, the movie trailer will be available for streaming a limited number of times. Thus, those interested in the movie will have incentives to promote the movie to those in their social network and to track the progress of the endorsements to determine when the trailer will be available for streaming.

The embodiments of the invention described herein are illustrative, rather than restrictive. Modification may be made without departing from the spirit of the invention as defined by the following claims and their equivalents.

1. A method for providing a promotion over a computer network, comprising:
determining a potential promotion for an item;
determining a threshold number of uncommitted endorsements required to unlock the potential promotion;
displaying the potential promotion and the threshold number of uncommitted endorsements to at least one potential buyer over the computer network before the threshold number is reached;
receiving endorsement data including an actual number of uncommitted endorsements made over the computer network;
tracking the actual number of uncommitted endorsements; and
unlocking the potential promotion for the item when the actual number of uncommitted endorsements reaches the threshold number, thereby converting the potential promotion to an actual promotion.

2. The method according to claim 1, wherein the uncommitted endorsements are endorsements for the item.

3. The method according to claim 1, further comprising displaying the actual number of uncommitted endorsements before the threshold number is reached.

4. The method according to claim 1, further comprising displaying the difference between the actual number of uncommitted endorsements and the threshold number before the threshold number is reached.

5. The method according to claim 1, wherein the displaying comprises displaying on a web site.

6. The method according to claim 1, wherein the displaying comprises displaying through a social networking application.

7. The method according to claim 1, wherein the displaying comprises displaying on a mobile device.

8. The method according to claim 1, wherein the uncommitted endorsements are provided through a social networking application.

9. The method according to claim 8, wherein the threshold number is a threshold number of uncommitted endorsements made by users in a particular social network through the social networking application and the tracking comprises tracking the actual number of uncommitted endorsements made by the users in the particular social network.

10. The method according to claim 1, wherein the uncommitted endorsements are made by scanning a machine-readable code.

11. The method according to claim 1, wherein the uncommitted endorsements are made by registering entry into a location.

12. The method according to claim 1, wherein the potential promotion and threshold number are displayed to a plurality of potential buyers and the unlocking comprises converting the potential promotion to an actual promotion for a subset of the plurality of potential buyers.

13. The method according to claim 12, wherein the subset consists of those of the plurality of potential buyers who provided the uncommitted endorsements.

14. The method according to claim 12, wherein the subset consists of those of the plurality of potential buyers who provided the uncommitted endorsements and those in their social network.

15. The method according to claim 1, wherein the potential promotion is unlocked only for a predetermined window of time after the threshold number is reached.

16. The method according to claim 1, wherein the potential promotion is unlocked only for a predetermined number of sales.

17. The method according to claim 1, further comprising providing an announcement that the potential promotion is unlocked when the threshold number is reached.

18. The method according to claim 17, wherein the announcement is provided on a web site.

19. The method according to claim 17, wherein the announcement is provided through a social networking application.

20. The method according to claim 17, wherein the announcement is provided on a mobile device.

21. The method according to claim 17, wherein the announcement is provided to those of the one or more potential buyers who provided an uncommitted endorsement.

22. The method according to claim 1, further comprising providing an announcement when the number of actual uncommitted endorsements is within a predetermined range of the threshold number.

23. The method according to claim 22, wherein the announcement is provided to those of the one or more potential buyers who provided an uncommitted endorsement.

24. The method according to claim 1, wherein the potential promotion is converted to an actual promotion by displaying a coupon in a social networking application.

25. The method according to claim 24, wherein the coupon is displayed on a personal page of a user of the social networking application.

26. The method according to claim 24, wherein the tracking comprises tracking users of the social networking application who made the uncommitted endorsements and wherein the coupon is displayed on a personal page of a user who made at least one of the uncommitted endorsements.

27. The method according to claim 26, further comprising tracking a number of sales made through the coupon and assigning a privileged status to the user if the number of sales reaches a predetermined amount.

28. A system for providing a promotion over a computer network, comprising:
a plurality of user terminals, each having a display, for displaying a potential promotion for an item and a threshold number of uncommitted endorsements required to unlock the potential promotion, and a user interface, for submitting user data signifying an uncommitted endorsement in response to the potential promotion;
a retailer interface coupled via said computer network to the plurality of user terminals, the retailer interface for submitting retailer data signifying the potential promotion for the item and the threshold number of uncommitted endorsements;
a promotion database coupled to the plurality of user terminals and the retailer interface for receiving and storing the user data and retailer data; and
a promotion processor coupled to plurality of user terminals, the retailer interface, and the promotion database for sending the potential promotion and the threshold number to the user terminal for display, analyzing the user data to determine an actual number of uncommitted endorsements received, comparing the actual number of uncommitted endorsements to the threshold number of uncommitted endorsements, and sending an announcement to at least one of the plurality of user terminals that the potential promotion is an actual promotion when the actual number of uncommitted endorsements is equal to or greater than the threshold number of uncommitted endorsements.
